(19) United States
(12) Patent Application Publication
(10) Pub. No.: US 2014/0337579 A1
(43) Pub. Date: Nov. 13, 2014

(54) ENTERTAINMENT MEMORY DEVICE

(71) Applicant: Victor Ibarra, Nashua, NH (US)

(72) Inventor: Victor Ibarra, Nashua, NH (US)

(21) Appl. No.: 13/889,632

(22) Filed: May 8, 2013

(51) Int. Cl. G06F 12/02

(52) U.S. Cl. CPC G06F 12/0246
USPC 711/115

(57) ABSTRACT

A digital memory device comprising: stick shaped memory chip; and read only memory. The digital memory device provides a means to store digital audio and video files for playback.

### cross reference to other applications This application claims priority to U.S. Provisional Application Ser. No. 61/644340 filed on May 8, 2012.

### BACKGROUND OF THE INVENTION

1. Field of Invention The present invention relates to a memory device that stores various audio and video media for entertainment purposes.

2. Description of Related Art

It is well known various memory devices are used to store entertainment media for playback. Various types of disks and tapes have been developed over the years for the storage of audio and video playback of various entertainment such as movies, music, speeches, spoken word and numerous recorded television programming. The most common forms of media playback include compact disc and DVD disks for playback of music and video any entertainment such as movies, television shows and various instructional or even documentary videos. The disk form of storage and playback requires care of the disk to avoid scratches or damage to the disk that could prohibit proper playback of the media on the disk. Further the disk may be destroyed through careless care in storing the disk when not used. Therefore it would advantageous to have an alternative storage media for the source of audio and video for playback.

### SUMMARY OF THE INVENTION

The present invention relates to a digital memory device comprising: stick shaped memory chip; and read only memory.

### BRIEF DESCRIPTION OF DRAWINGS

FIG. 1 depicts a side view of a memory stick for storage of audio and video entertainment for playback.

### DETAILED DESCRIPTION

The present invention relates to a storage medium used to store digital audio and digital video medium for playback. The digital storage stick according to the present invention is capable of retaining and storing digital and audio files in a format for playing back on various mediums such as television or computer. The storage stick according to present invention stores digital media and is received by a USB connection provided on a computer or a television. The storage stick plugs into a USB outlet or connects with the playback medium and allows for the playback of any audio/video stored on the digital storage stick.

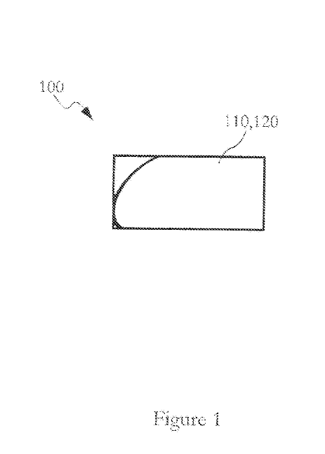

In reference to FIG. 1, a side view of a memory storage stick 100 is depicted. The memory storage stick includes read only memory which stores the digital files associated with the music or video stored on the memory stick 100. Digital video files 110 are shown in FIG. 1 also the digital stick stores audio files 120 as graphically depicted. These files are stored on the read only memory provided on the digital memory stick in accordance with the present invention. In one particular embodiment, the memory stick 100 is approximately three and one half inches in width and two and a half inches long and is compatible with existing digital slots found on televisions and computers. This video playback slot is normally a USB type connection and therefore interacts with playback software that may be available on the memory provided of the computer and/or television. A user may simply insert the digital storage stick into the desired device and may enjoy watching a show or listening to music that resides in the memory provided on the memory stick 100. The memory stick 100 may be sold with the digital audio or video prerecorded and stored on the memory stick prior to use. This type of distribution helps to insure a proper licensing and copyright laws are provided to protect the substance of the digital files provided on the memory stick 100. The digital media may also be transferred and stored onto a memory card and therefore be compatible with other card readers available for playback. The instant invention has been shown and described in what it considers to be the most practical and preferred embodiments. It is recognized, however, that departures may be made there from within the scope of the invention and that obvious modifications will occur to a person skilled in the art.

What is claimed is:

1. A digital memory device comprising:
a. stick shaped memory chip; and
b. read only memory, where the memory is capable of storing digital audio and video files.
